(19) United States
(12) Patent Application Publication
(10) Pub. No.: US 2023/0214365 A1
(43) Pub. Date: Jul. 6, 2023

(54) METHOD FOR STORING DATA

(71) Applicant: TmaxEnterprise Co., Ltd., Gyeonggi-do (KR)

(72) Inventors: Seokwoo Ahn, Seoul (KR); Myongsik Gong, Gyeonggi-do (KR); Daeun Jeong, Gyeonggi-do (KR); Kyungil Cho, Gyeonggi-do (KR); Sangyeon Woo, Gyeonggi-do (KR)

(21) Appl. No.: 17/652,135

(22) Filed: Feb. 23, 2022

(30) Foreign Application Priority Data
Jan. 6, 2022 (KR) 10-2022-0001898
Feb. 21, 2022 (KR) 10-2022-0022429

(51) Int. Cl. G06F 16/182

(52) U.S. Cl. CPC G06F 16/183

(57) ABSTRACT

Disclosed is a method for storing data performed by a server including at least one processor. The method for storing the data may include: when first sensing data and second sensing data are received from an external sensor, determining whether to store the first sensing data and the second sensing data in an external storage; when determining to store the first sensing data and the second sensing data in the external storage, transmitting a first content identifier (CID) generated as the first sensing data is stored in the external storage and a second CID generated as the second sensing data is stored in the external storage to at least one node included in the blockchain network to cause a plurality of nodes to record the first CID and the second CID in the block through the agreement algorithm; determining whether there is a change for a sensing value based on a comparison result for a second sensing value included in the second sensing data and a first sensing value included in the first sensing data; and when it is determined that there is the change, transmitting the comparison result to at least one node included in the blockchain network to cause the plurality of nodes to record the comparison result in the block through an agreement algorithm.

### CROSS-REFERENCE TO RELATED APPLICATIONS

This application claims priority to and the benefit of Korean Patent Application No. 10-2022-0001898 filed in the Korean Intellectual Property Office on Jan. 06, 2022, and Korean Patent Application No. 10-2022-0022429 filed in the Korean Intellectual Property Office on Feb. 21, 2022 the entire contents of which are incorporated herein by reference.

### TECHNICAL FIELD

The present disclosure relates to a method for storing data, and particularly, to a method for storing data collected from an external sensor.

This work was supported by the Industrial Technology Innovation Program (20003722, Development of block chain platform for distribution history management and product certification services) funded By the Ministry of Trade, Industry & Energy (MOTIE, Korea).

### BACKGROUND ART

An Internet of things (IoT) device may be technology that embeds a sensor and a communication function in various things. Here, the things may be various embedded systems such as household appliances, mobile equipment, or wearable devices. Things connected to Internet of things (IoT) may acquire sensing data from an external environment through an embedded sensor. The things connected to the IoT are also connected to the Internet to transfer the acquired sensing data to the outside. All things may become targets of viruses and hackings, so the development of the IoT device and the development of security may be accompanied jointly.

However, due to low performance of the IoT device, there may be various problems in applying conventional security technologies to IoT device environments. For example, in a network field using a general computing device other than the IoT device environment, a network having excellent security, such as a blockchain is developed. However, it is necessary to transact all IoT data in order to apply the blockchain network to the IoT environment, but there may be a problem in that a lot of time is required for transacting data in the IoT device. In addition to the time, a process of transacting the IoT data is also complicated, and as a result, there may also be a problem in that efficiency of storage is also low in directly storing the data by the IoT device.

### SUMMARY OF THE INVENTION

The present disclosure has been made in an effort to provide a method for storing sensing data sensed through an external sensor such as an IoT device.

However, technical objects of the present disclosure are not restricted to the technical object mentioned as above. Other unmentioned technical objects will be apparently appreciated by those skilled in the art by referencing to the following description.

An exemplary embodiment of the present disclosure provides a method for storing data performed by a server including at least one processor. The method for storing the data may include: when first sensing data and second sensing data are received from an external sensor, determining whether to store the first sensing data and the second sensing data in an external storage; when determining to store the first sensing data and the second sensing data in the external storage, transmitting a first content identifier (CID) generated as the first sensing data is stored in the external storage and a second CID generated as the second sensing data is stored in the external storage to at least one node included in the blockchain network to cause a plurality of nodes to record the first CID and the second CID in the block through the agreement algorithm; determining whether there is a change for a sensing value based on a comparison result for a second sensing value included in the second sensing data and a first sensing value included in the first sensing data; and when it is determined that there is the change, transmitting the comparison result to at least one node included in the blockchain network to cause the plurality of nodes to record the comparison result in the block through an agreement algorithm.

The external storage is a InterPlanetary File System (IPFS) type of storage.

When determining to store the first sensing data and the second sensing data in the external storage, the transmitting of the first content identifier (CID) generated as the first sensing data is stored in the external storage and the second CID generated as the second sensing data is stored in the external storage to at least one node included in the blockchain network to cause the plurality of nodes to record the first CID and the second CID in the block through the agreement algorithm may include generating a first transaction with the first CID as a payload and a second transaction with the second CID as a payload, and transmitting the first transaction and the second transaction to at least one node included in the blockchain network to cause the first CID and the second CID to be recorded in a block.

The second sensing data may be data received after the first sensing data is received, and when the first sensing data and the second sensing data are received from the external sensor, the determining of whether to store the first sensing data and the second sensing data in the external storage may include determining whether sensing data of a predetermined amount or more is collected as the second sensing data is received, and storing the first sensing data and the second sensing data in the external storage when it is determined that the sensing data of the predetermined amount or more is collected.

The storing of the first sensing data and the second sensing data in the external storage may include splitting the first sensing data into the object unit and generating a first set of objects, and splitting the second sensing data into the object unit and generating a second set of objects, and hashing the first set of objects and the second set of objects, and storing the hashed object in the external storage.

Each of the first set of objects and the second set of objects may be hashed in a merkle Directed Acyclic Graph (DAG) structure, and stored in the external storage.

The determining of whether there is the change for the sensing value based on the comparison result for the second sensing value included in the second sensing data and the first sensing value included in the first sensing data may include determining that there is the change when it is determined that the first sensing value and the second sensing value are different, or determining that there is the change when it is determined that a difference between the first sensing value and the second sensing value is a predetermined first threshold or more.

The method may further include: generating a smart contract which generates notification information to be provided to a user based n the comparison result; and transmitting the smart contract to at least one node included in the blockchain network to cause the plurality of nodes to record the smart contract in the block through the agreement algorithm.

The smart contract may determine a change value for the sensing value based on the comparison result, and generate the notification information when the change value is a predetermined second threshold or more.

Another exemplary embodiment of the present disclosure provides a server for storing data, which includes: a communication unit receiving first sensing data and second sensing data from an external sensor; and a processor determining whether to store the first sensing data and the second sensing data in an external storage when the first sensing data and the second sensing data are received from the external sensor, in which the processor when determining to store the first sensing data and the second sensing data in the external storage, transmits a first content identifier (CID) generated as the first sensing data is stored in the external storage and a second CID generated as the second sensing data is stored in the external storage to at least one node included in the blockchain network through the communication unit to cause a plurality of nodes to record the first CID and the second CID in the block through the agreement algorithm, determines whether there is a change for a sensing value based on a comparison result for a second sensing value included in the second sensing data and a first sensing value included in the first sensing data, and when it is determined that there is the change, transmits the comparison result to at least one node included in the blockchain network through the communication unit to cause the plurality of nodes to record the comparison result in the block through an agreement algorithm.

Still another exemplary embodiment of the present disclosure provides a computer program stored in a computer-readable storage medium, wherein when the computer program is executed by one or more processors, the computer program executes a method for storing data, and the method may include: when first sensing data and second sensing data are received from an external sensor, determining whether to store the first sensing data and the second sensing data in an external storage; when determining to store the first sensing data and the second sensing data in the external storage, transmitting a first content identifier (CID) generated as the first sensing data is stored in the external storage and a second CID generated as the second sensing data is stored in the external storage to at least one node included in the blockchain network to cause a plurality of nodes to record the first CID and the second CID in the block through the agreement algorithm; determining whether there is a change for a sensing value based on a comparison result for a second sensing value included in the second sensing data and a first sensing value included in the first sensing data; and when it is determined that there is the change, transmitting the comparison result to at least one node included in the blockchain network to cause the plurality of nodes to record the comparison result in the block through an agreement algorithm.

Technical solving means which can be obtained in the present disclosure are not limited to the aforementioned solving means and other unmentioned solving means will be clearly understood by those skilled in the art from the following description.

According to some exemplary embodiments of the present disclosure, a method for storing data having enhanced security can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 illustrates an exemplary system for performing an example of a method for storing data by a server according to some exemplary embodiments of the present disclosure.

FIG. 2 is a flowchart for describing an example of a method for storing sensing data by a server according to some exemplary embodiments of the present disclosure.

FIG. 3 is a flowchart for describing an example of a method for storing at least one sensing data in an external storage by the server.

FIG. 4 is a flowchart for describing an example of a method for storing at least one sensing data in an external storage by the server.

FIG. 5 is a flowchart for describing an example of a method for recording a smart contract in a blockchain network by a server according to some exemplary embodiments of the present disclosure.

FIG. 6 illustrates an exemplary system for performing an example of a method for storing data by a server according to some exemplary embodiments of the present disclosure.

FIG. 7 is a general schematic view of an exemplary computing environment in which exemplary embodiments of the present disclosure may be implemented.

### DETAILED DESCRIPTION

Various exemplary embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present invention pertains. Terms defined in commonly used dictionaries should not be interpreted in an idealized or excessive sense unless expressly and specifically defined.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

In addition, the word “comprises” and/or “comprising” means that the corresponding feature and/or component is present, but it should be appreciated that presence or addition of one or more other features, components, and/or a group thereof is not excluded. Further, when not separately specified or it is not clear in terms of the context that a singular form is indicated, it should be construed that the singular form generally means “one or more” in this specification and the claims.

Further, the terms “information” and “data” used in the specification may also be often used to be exchanged with each other.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another component, no component is present between the component and another component.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention or a usual practice of a user or an operator.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

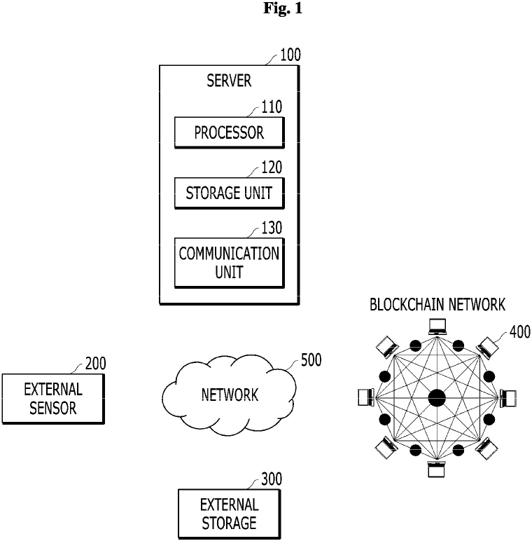

In the present disclosure, a server may receive at least one sensing data sensing an external environment from an external sensor. The external sensor may be, for example, an Internet of things (IoT) device or a sensor embedded in the IoT device. The sensing data may be data acquired by sensing a temperature or humidity inside a moving body. For example, the external sensor may be a sensor provided in a storage box of a vehicle carrying a food material, and in this case, the sensing data may be data acquired by sensing the temperature or humidity of the storage box. The server may store at least one received sensing data in an external storage. The external storage may be a separate storage implemented independently from the server. For example, the external storage may be a storage implemented in a form of Interplanetary File System (IPFS). The IPFS may be a protocol that hashes, and distributively stores massive data. The IPFS as a hyper media protocol processed by a file and an identifier (ID) may be a distributed file system. In the present disclosure, the external storage may generate a content identifier (CID) in storing at least one sensing data received from the server. The CID may be information for identifying each of at least one sensing data stored in the external storage. The server may call or process at least one sensing data stored in the external storage through the generated CID. As a result, the server may enhance storage efficiency of the data in storing at least one data generated from the external sensor. Additionally, according to some exemplary embodiments of the present disclosure, the server may sense generation of abnormal data in consecutively receiving at least one sensing data. Hereinafter, a method for storing data by the server according to the present disclosure will be described through FIGS. 1 to 6.

FIG. 1 illustrates an exemplary system for performing an example of a method for storing data by a server according to some exemplary embodiments of the present disclosure.

Referring to FIG. 1, a server 100 may include a processor 110, a storage unit 120, and a communication unit 130. However, components described above are not required in implementing the server 100 and the server 100 may thus have components more or less than components listed above.

The server 100 may include, for example, a predetermined type of computer system or computer device such as a microprocessor, a mainframe computer, a digital processor, a portable device, and a device controller.

The processor 110 may control an overall operation of the server 100. The processor 110 processes a signal, data, information, and the like input or output through the components of the server 100 or drives the application program stored in the memory to provide or process appropriate information or function.

The processor 110 may be constituted by one or more cores and may include processors for data analysis, which include a central processing unit (CPU), a general purpose graphics processing unit (GPGPU), a tensor processing unit (TPU), and the like of the game server 100.

In the present disclosure, when the processor 110 receives at least one sensing data from the external sensor 200, the processor 110 may determine whether to store at least one received sensing data in the external storage 300.

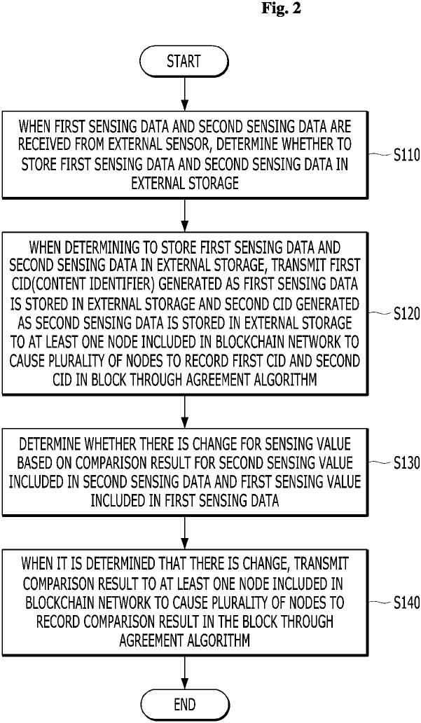

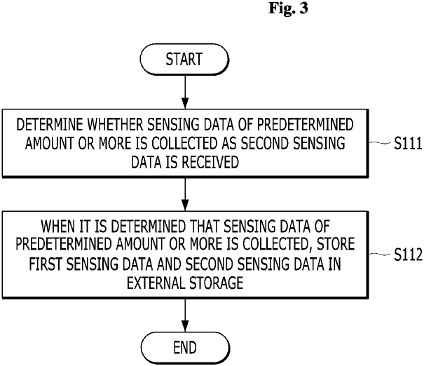

Specifically, the communication unit 130 may receive first sensing data from the external sensor 200 and receive second sensing data after receiving the first sensing data. The processor 110 may determine whether sensing data of a predetermined amount or more is collected as the second sensing data is received. The predetermined amount may be predetermined information based on at least one of a size of data and the number of data. When the processor 110 determines that the sensing data of the predetermined amount or more is collected, the processor 110 may store the first sensing data and the second sensing data in the external storage 300. As the processor 110 determines whether to store at least one sensing data in the external storage 300 by such a scheme, a load which may be generated in the processor 110 or the communication unit 130 may be reduced. When the processor 110 stores the sensing data in the external storage 300 through the communication unit 130 each time the sensing data is received from the external sensor 200, an excessive load may be generated in the processor 110 and the communication unit 130. Accordingly, when the processor 110 receives at lest one sensing data from the external sensor 200, the processor 110 may determine whether to store at least one received sensing data in the external storage 300. Hereinafter, an example of determining whether to store at least one sensing data in the external storage 300 by the processor 110 will be described through FIGS. 2 and 3.

The storage unit 120 may include a memory and/or a persistent storage medium. The memory may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The storage unit 120 may include one or more memories including a buffer cache. Here, the memory as a primary storage device directly accessed by the processor 110, such as a random access memory (RAM) including a dynamic random access memory (DRAM), a static random access memory (SRAM), etc., may mean a volatile storage device in which stored information is momentarily erased when power is turned off, but is not limited thereto. The memory may be operated by the processor 110. The memory may include a buffer cache and data may be stored in a data block of the buffer cache. The data may be recorded in the storage unit 120 by a background process.

The storage unit 120 may store any type of information created or determined by the processor 110 or any type of information received by the communication unit 130. As an example, the storage unit 120 may temporarily store at least one sensing data until the processor 110 determines whether to store at least one sensing data in the external storage 300.

The communication unit 130 may include one or more modules which enable communication between the server 100 and the communication system, between the server 100 and the external sensor 200, between the server 100 and the external storage 300, between the server 100 and the blockchain network 400, or between the server 100 and the network 500. The communication unit 130 may include at least one of a wired Internet module, and a wireless Internet module.

In the present disclosure, the communication unit 130 may receive at least one sensing data from the external sensor 200. The communication unit 130 may transfer at least one sensing data to the external storage 300 so that at least one sensing data is stored in the external storage 300.

The external sensor 200 may be a terminal implemented through an Internet of Things (IoT) technology. The external sensor 200 may transmit sensing data acquired by sensing an external environment to the server 100.

In the present disclosure, the external sensor 200 may transmit sensing data generated by sensing an internal environment of the moving body to the server 100. The sensing data may be data acquired by sensing a temperature or humidity inside a moving body.

The external storage 300 may store predetermined type of information received from the server 100. For example, the external storage 300 may be a storage implemented in a form of InterPlanetary File System (IPFS). The IPFS may be a protocol that hashes, and distributively stores massive data. The external storage 300 may generate a content identifier (CID) in storing at least one sensing data received from the server 100. The CID may be information for identifying each of at least one sensing data stored in the external storage 300. The server 100 may call or process at least one sensing data stored in the external storage 300 through the CID.

The blockchain network 400 may mean a network which records at least one CID generated by the external storage 300. Alternatively, the blockchain network 400 may record at least one sensing data received from the server 100.

The blockchain network 400 is a network including a plurality of nodes, and the nodes included in the blockchain network 400 may be operated by a blockchain core package according to a hierarchical structure. The structure may include a data layer defining a structure of data handled in the blockchain network 400 and managing the data, an agreement layer performing mining of verifying validity of a block and generating the block, and processing of a commission paid to a miner during a mining process, a P2P network protocol, a hash function, an electronic signature, a common layer managing encoding and implementing a common storage, and an application layer generating, processing, and managing various applications.

Meanwhile, in some exemplary embodiments of the present disclosure, the plurality of nodes included in the blockchain network 400 may be a full block chain node and also be a lightweight node.

The full block chain node may include information on all blocks from an initial block of the blockchain up to a newly generated block. Further, the full block chain node may serve to collect and store all blockchain information, and perform verification for a block transferred to add a new block.

The lightweight node does not have an original of all block information, but may include only header information. Simple payment verify (SPV) may be performed in order for the lightweight node to verify the transaction.

For example, the lightweight node may request the block information to the full block chain node and verify authentication contents of the transaction through Merkle Root.

However, for convenience of description it is assumed and described below that the plurality of nodes included in the blockchain network 400 are the full block chain node.

Each of the nodes included in the blockchain network 400 may record a smart contract or a transaction including the smart contract in the block through an agreement algorithm. However, the present disclosure is not limited thereto.

Meanwhile, according to some exemplary embodiments of the present disclosure, when the server 100 recognizes that an execution condition of at least one smart contract is satisfied, the sever 100 may perform a corresponding action based on an instruction received from the smart contract. In this case, when the server 100 synchronizes a function of the smart contract included in the transaction in a compiled code form through the blockchain in executing the action, the smart contract may be implemented by a scheme of executing a function expressed as a code with information included in the transaction as an input of the function, and then storing a result of the execution as a separate state.

When contents of the function and the input of the function are shared by the smart contract shared by the blockchain network 400, integrity of the data may be guaranteed even though the result of the function is not separately shared.

The plurality of nodes included in the blockchain network 400 may share and store at least one of the generated transaction and the smart contract through the network. Further, when verification at least one of the transaction and the smart contract is completed through the agreement algorithm of the blockchain technology, the plurality of nodes may perform a function of recording the transaction in the block. The block as a unit in which at least one of the smart contract and the transaction is stored in the blockchain network 400 is connected to contiguous blocks to form the blockchain.

The agreement algorithm performed in the blockchain network 400 may include at least one of a Proof of Work (PoW) algorithm, a Proof of Stake (PoS) algorithm, a Delegated Proof of Stake (DPoS) algorithm, a Practical Byzantine Fault Tolerance (PBFT) algorithm, a Delegated Byzantine Fault Tolerance (DBFT) algorithm, a Redundant Byzantine Fault Tolerance (RBFT) algorithm, a Sieve algorithm, a Tendermint algorithm, a Paxos algorithm, a Raft algorithm, a Proof of Authority (PoA) algorithm, and a Proof of Elapsed Time (PoET) algorithm.

Since at least one of the smart contract and the transaction is recorded in the block by using the agreement algorithm of the blockchain technology, there is an effect that forgery or falsification of the CID received from the server 100 may be prevented.

Meanwhile, the structure of the blockchain network 400 according to some exemplary embodiments of the present disclosure may be a public type or a private type. In the case of the public type blockchain network 400, since a verification task for all nodes should be performed in order to verify the transaction, there is a disadvantage in that it is inefficient in terms of an agreement time, a processing speed of the transaction, and use efficiency of a computing resource, but since it is possible for an arbitrary node to participate in the verification, there may be an advantage in transparency and integrity of the stored data. Further, in the case of the private type (or consortium type) blockchain, since an operating entity is clear, there is an advantage in that it is efficient in terms of the agreement time, the processing speed of the transaction, and the use efficiency of the computing resource, but there may be a disadvantage in terms of transparency for a transaction processing process and a transaction processing result.

As the agreement algorithm according to some exemplary embodiments of the present disclosure, the private type or consortium type blockchain network 400 may be preferable to enhance a user experience through an increase of efficient utilization of the computing resource and the processing speed of the transaction, but the agreement algorithm is not limited thereto, and as the agreement algorithm, the public type may be used in order to further emphasize transparency the transaction or the smart contract according to an implementation aspect.

When the smart contract is recorded in the blockchain network 400, it is actually impossible that the smart contract is forged or falsified. Accordingly, it is possible to prevent the third party from modifying the smart contract recorded in the blockchain network 400.

The network 500 may be configured regardless of communication modes such as wired and wireless modes and constituted by various communication networks including a personal area network (PAN), a local area network (LAN), a wide area network (WAN), and the like. Further, the network may be known World Wide Web (WWW) and may adopt a wireless transmission technology used for short-distance communication, such as infrared data association (IrDA) or Bluetooth. The techniques described in this specification may also be used in other networks in addition to the aforementioned networks.

According to the above-described configuration, the server 100 may receive at least one sensing data from the external sensor 200. The server 100 may store at least one received sensing data in the external storage 300. The server 100 may record a CID generated in the process of storing at least one sensing data in the external storage 300 in the blockchain network 400. When the CID is recorded in the blockchain network 400, the integrity of the CID may be guaranteed. Hereinafter, the method for storing, by the server 100, the sensing data received from the external sensor 200 will be described in more detail.

FIG. 2 is a flowchart for describing an example of a method for storing sensing data by a server according to some exemplary embodiments of the present disclosure. Referring to FIG. 2, when the processor 110 of the server 100 receives the first sensing data and the second sensing data from the external sensor 200, the processor 110 of the server 100 may determine whether to store the first sensing data and the second sensing data in the external storage 300 (S 110).

The processor 110 may determine whether sensing data of a predetermined amount or more is collected as the second sensing data is received. Here, the second sensing data may be data received after the first sensing data is received. The second sensing data may be data generated by the external sensor 200 after the first sensing data is generated. The second sensing data and the first sensing data may be consecutively received from the external sensor 200. The predetermined amount may be appreciated as information predetermined based on at least one of the size of data and the number of data.

For example, the processor 110 may determine a quantitative size acquired by adding the first sensing data and the second sensing data as the second sensing data is received. As it is determined that the quantitative size acquired by adding the first sensing data and the second sensing data is a predetermined size or more, the processor 110 may store the first sensing data and the second sensing data in the external storage 300 through the communication unit 130. As another example, as the second sensing data is received, the processor 110 may determine that the number of received sensing data is a predetermined number or more. As it is determined that the number of received sensing data is the predetermined number or more, the processor 110 may store the first sensing data and the second sensing data in the external storage 300 through the communication unit 130.

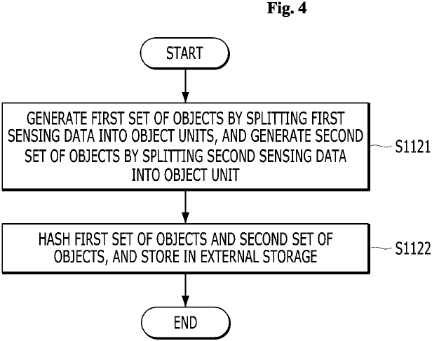

According to some exemplary embodiments of the present disclosure, the processor 110 may split the first sensing data and the second sensing data into an object unit, and store the split object unit in the external storage 300. The object unit may be appreciated as a bundle unit such as a variable, a data structure, a function, and a method that perform one role. The processor 110 may split the first sensing data into the object unit and generate a first set of objects, and split the second sensing data into the object unit and generate a second set of objects. Alternatively, as the second sensing data is received, the processor 110 may split the first sensing data and the second sensing data into the object unit, and generate a third set of objects. The processor 110 may hash the first set of objects, the second set of objects, or the third set of objects, and store the hashed objects in the external storage 300. Here, hashing may be a security algorithm for preventing forgery and falsification of data. Hereinafter, an example of splitting the first sensing data and the second sensing data into the object unit, and storing the split object unit by the processor 110 will be described through FIG. 4.

When the processor 110 determines to store the first sensing data and the second sensing data in the external storage 300, the processor 110 transmits a first content identifier (CID) generated as the first sensing data is stored in the external storage and a second CID generated as the second sensing data is stored in the external storage 300 to at least one node included in the blockchain network 400 through the communication unit 130 to cause a plurality of nodes to record the first CID and the second CID in the block through the agreement algorithm (S120). The CID may be information for identifying each of at least one sensing data stored in the external storage 300.

Specifically, the processor 110 may generate a first transaction which payloads the first CID and a second transaction which payloads the second CID. The payload may be data to be transmitted in a component that forms data. For example, the data may be constituted by information such as a header, a body, and meta data, and the payload may correspond to a body. In other words, the first transaction may be a transaction having the first CID as the body and the second transaction may be a transaction having the second CID as the body. The processor 110 transmits the first transaction and the second transaction to at least one node included in the blockchain network 400 through the communication unit 130 to cause the first CID and the second CID to be recorded in the block. When the first CID and the second CID are recorded in the blockchain network 400, the processor 110 may call the first sensing data and the second sensing data stored in the external storage 300 through the first CID and the second CID recorded in the blockchain network 400.

Through the above-described paragraph, loads which are generated in the processor 110 and the communication unit 130 may be reduced. Specifically, the processor 110 should be able to transact the first sensing data and the second sensing data in order to record the first sensing data and the second sensing data in the blockchain network 400. However, the sensing data may be data which has a relatively larger size than the CID, and include a lot of information. As a result, an operation of the processor 110 which transacts the sensing data may cause a larger load than an operation of transacting the CID. Moreover, the transaction generated from the sensing data may also have a larger size than the transaction generated from the CID. As a result, a size of data which should be transmitted by the communication unit 130 may also be large. Accordingly, the processor 110 according to the present disclosure may store the first sensing data and the second sensing data in the external storage 300. The processor 110 may generate a first transaction which payloads the first CID and a second transaction which payloads the second CID. In addition, the communication unit 130 transmits the first transaction and the second transaction to at least one node included in the blockchain network 400 to cause the first CID and the second CID to be recorded in the block. As a result, the loads which may be generated in the processor 110 and the communication unit 130 may be reduced.

According to some exemplary embodiments of the present disclosure, the processor 110 transmits the first CID and the second CID to at least one node included in the blockchain network 400 through the communication unit 130 to cause the first CID and the second CID to be recorded in the block as the payload.

Specifically, the block which is a storage unit in the blockchain network 400 may be constituted by a block header and a block body. The block header may include a hash value and a Nonce value of a previous block header. The Nonce value as a value which the node in the blockchain network 400 changes to generate the block may be used as an input value of a specific hash function jointly with another value of the block header. When a specific Nonce value is used, if the hash value of the block header is smaller than a predetermined difficulty value (which may be stored in the block header), the hash value for the corresponding block header may be determined. The block body may be a set constituted by transaction information. The first CID may be recorded in a block body of a first block among a plurality of blocks constituting the blockchain network 400 as the payload. The second CID may be recorded in a block body of a second block among the plurality of blocks constituting the blockchain network 400 as the payload. Alternatively, the first CID and the second CID may be recorded in a block body of a third block among the plurality of blocks constituting the blockchain network 400 as the payload.

The processor 110 may determine whether there is a change for a sensing value based on a comparison result for a second sensing value included in the second sensing data and a first sensing value included in the first sensing data (S130).

As an example, when it is determined that the first sensing value and the second sensing value are different, the processor 110 may determine that there is the change. For example, the first sensing data and the second sensing data may be data acquired by sensing an internal temperature of the moving body by the external sensor 200. An internal temperature value of the moving body, which is represented by the first sensing value included in the first sensing data may be 26° C. The internal temperature value of the moving body, which is represented by the second sensing value included in the second sensing data may be 27° C. In this case, since the first sensing value and the second sensing value are different, the processor 110 may determine that there is the change for the sensing value.

As another example, when a difference between the first sensing value and the second sensing value is a predetermined threshold or more, the processor 110 may determine that there is the change. For example, the internal temperature value of the moving body, which is represented by the first sensing value may be 26° C. and the internal temperature value of the moving body, which is represented by the second sensing value may be 27° C. A predetermined first threshold may be 2° C. In this case, since the difference between the first sensing value and the second sensing value is less than the predetermined first threshold value, the processor 110 may determine that there is no change for the sensing value.

When it is determined that there is the change, the processor 110 transmits the comparison result to at least one node included in the blockchain network 400 through the communication unit 130 to cause the plurality of nodes to record the comparison result in the block through the agreement algorithm (S140). When the comparison result is recorded in the blockchain network 400, the comparison result may be prevented from being modified by the third party, thereby guaranteeing the integrity.

According to some exemplary embodiments of the present disclosure, when it is determined that there is the change, the processor 110 transmits the first sensing data and the second sensing data to at least one node included in the blockchain network 400 through the communication unit 130 to cause the plurality of nodes to record the first sensing data and the second sensing data in the block through the agreement algorithm. In other words, when there is no change for the sensing value according to the comparison result for the first sensing value and the second sensing value, the processor 110 may not transmit the first sensing data and the second sensing data to the blockchain network 400. When there is the change for the sensing value according to the comparison result for the first sensing value and the second sensing value, the processor 110 may transmit the first sensing data and the second sensing data to the blockchain network 400.

According to some exemplary embodiments of the present disclosure, the processor 110 may generate a smart contract which generates notification information to be provided to the user based on the comparison result. The processor 110 transmits the generated smart contract to at least one node included in the blockchain network 400 through the communication unit 130 to cause the plurality of nodes to record the smart contract in the block through the agreement algorithm. The notification information may be information for transferring a notification to a user related to the external sensor 200. As an example, the notification information may be information for transferring the notification to a user who operates the moving body.

The smart contract may be a function in which an action and an execution condition are created in advance as a digital language, and the action is automatically executed when the corresponding condition is satisfied. When at least one of the code and the function included in the smart contract is executed, a predetermined type of operation according to some exemplary embodiments may be performed.

Specifically, the smart contract according to the present disclosure may determine a change value for the sensing value based on the comparison result, and generate notification information when the change value is a predetermined second threshold or more.

For example, the internal temperature value of the moving body, which is represented by the first sensing value may be 24° C. and the internal temperature value of the moving body, which is represented by the second sensing value may be 27° C. Since the second sensing value is different from the first sensing value, the comparison result of the first sensing value and the second sensing value may be recorded in the blockchain network 400. The comparison result recorded in the blockchain network 400 may include information on the change value being 3° C. The smart contract may determine that the change value for the sensing value is 3° C. based on the comparison result recorded in the blockchain network 400. The predetermined second threshold for the change value stored in the storage unit 120 may be 3° C. When a change value changed from the first sensing value to the second sensing value is 3° C. or more, the smart contract may generate the notification information.

When the notification information is generated, the communication unit 130 may transmit the notification information to a terminal of the user related to the external sensor 200. Alternatively, when the external sensor 200 is the user terminal, the communication unit 130 may also transmit the notification information to the user terminal. As a result, the user confirms the notification information to control the internal temperature or humidity of the moving body.

According to the above-described configuration, the server 100 transmits the transaction of payloading the CID and the comparison result to at least one node included in the blockchain network 400 to cause the plurality of nodes to record the CID and the comparison result in the block through the agreement algorithm. When the server 100 transacts the sensing data received from the external sensor 200 and records the transacted sensing data in the blockchain network 400, a large load may be generated in the server 100. According to the above-described configuration, the server 100 transmits the transaction of payloading the CID to at least one node included in the blockchain network 400 to cause the plurality of nodes to record the CID in the block through the agreement algorithm. Moreover, when the server 100 does not determine whether there is the change for the sensing value, and transacts the comparison result each time the sensing data is received, and records the comparison result in the blockchain network 400, this may also cause the large load to be generated. Accordingly, when it is determined that there is the change for the sensing value based on the comparison result, the server 100 may record the comparison result in the blockchain network 400. As a result, the load generated in the server 100 may be reduced and efficiency of data storing may be enhanced.

According to some exemplary embodiments of the present disclosure, when sensing data of a predetermined amount or more is collected, the server 100 may store at least one sensing data in the external storage 300. Hereinafter, a method for storing at least one sensing data in the external storage 300 by the server 100 will be described.

FIG. 3 is a flowchart for describing an example of a method for storing at least one sensing data in an external storage by the server.

Referring to FIG. 3, the processor 110 of the server 100 may determine whether sensing data of a predetermined amount or more is collected as the second sensing data is received (S111).

Specifically, the communication unit 130 may receive first sensing data from the external sensor 200 and receive second sensing data after receiving the first sensing data. The processor 110 may determine whether sensing data of a predetermined amount or more is collected as the second sensing data is received. When the second sensing data is not received, the processor 110 may not determine whether the sensing data of the predetermined amount or more is collected, and wait until the second sensing data is received.

When it is determined that the sensing data of the predetermined amount or more is collected, the processor 110 may store the first sensing data and the second sensing data in the external storage 300 (S112).

For example, the processor 110 may determine a quantitative size acquired by adding the first sensing data and the second sensing data as the second sensing data is received. As it is determined that the quantitative size acquired by adding the first sensing data and the second sensing data is a predetermined size or more, the processor 110 may store the first sensing data and the second sensing data in the external storage 300 through the communication unit 130. As another example, as the second sensing data is received, the processor 110 may determine that the number of received sensing data is a predetermined number or more. As it is determined that the number of received sensing data is the predetermined number or more, the processor 110 may store the first sensing data and the second sensing data in the external storage 300 through the communication unit 130.

According to the above-described configuration, the server 100 may determine whether to store at least one sensing data in the external storage 300. When at least one sensing data is stored in the external storage 300 each time at least one sensing data is received from the external sensor 200, an excessive load may be generated in the server 100. Accordingly, when at lest one sensing data is received from the external sensor 200, the server 100 may determine whether to store at least one received sensing data in the external storage 300. As a result, the load which may be generated in the server 100 may be reduced.

According to some exemplary embodiments of the present disclosure, the server 100 may split the sensing data into an object unit, and store the split object unit in the external storage 300. Hereinafter, a method for splitting the sensing data into the object unit, and storing the object unit in the external storage 300 by the server 100 will be described.

FIG. 4 is a flowchart for describing an example of a method for storing at least one sensing data in an external storage by the server.

Referring to FIG. 4, the processor 110 of the server 100 may split the first sensing data into the object unit and generate a first set of objects, and split the second sensing data into the object unit and generate a second set of objects (S1121). The object unit may be appreciated as a bundle unit such as a variable, a data structure, a function, and a method that perform one role.

According to the exemplary embodiment, the external storage 300 may be a storage of an Interplanetary File System (IPFS) type. Since data stored in the IPFS type storage need to be split into the object unit and stored, the processor 110 may generate a first set of objects from the first sensing data and generate a second set of objects from the second sensing data.

According to some exemplary embodiments of the present disclosure, the processor 110 may also generate a third set of objects from the first sensing data and the second sensing data. In other words, when sensing data of a predetermined amount or more is collected, the processor 110 may also generate the third set of objects by using all of the sensing data of the predetermined amount or more.

The processor 110 may hash the first set of objects and the second set of objects, and store the hashed objects in the external storage 300 (S1122).

Specifically, the processor 110 may hash each of the first set of objects and the second set of objects in a merkle Directed Acyclic Graph (DAG) structure, and store the hashed objects in the external storage 300. The merkle DAG structure may be a data structure used for the hash to refer to a data block and an object in a DAG. The merkle DAG structure may be a structure in which a merkle tree and the DAG are combined. The merkle tree may be a tree type of data structure in which child nodes have a data block configured by a cryptographic hash. The DAG as an abbreviation of directed acyclic graph without direction cycle may be a method for modeling only topological information. According to the exemplary embodiment, the external storage 300 may be a storage of an Interplanetary File System (IPFS) type. Since data stored in the IPFS type storage need to be split into the object unit and stored, the processor 110 may generate a first set of objects from the first sensing data and generate a second set of objects from the second sensing data. When the first set of objects and the second set of objects are stored in the IPFS, the objects may be hashed and stored in the merkle DAG structure. As a result, when data is changed, a hash value may be changed, and a case where the hash value is changed may represent that the data is damaged.

According to the above-described configuration, the server 100 may store at least one sensing data through the external storage 300 capable of distributing and storing data. Further, since the data stored in the external storage 300 is hashed in the merkle DAG structure, and stored, the integrity of the data may be guaranteed.

According to some exemplary embodiments of the present disclosure, the server 100 may generate a smart contract which generates notification information to be provided to a user based on a comparison result between a first sensing value of first sensing data and a second sensing value of second sensing data. Hereinafter, a method for generating the smart contract and recording the generated smart contract in the blockchain network 400 by the server 100 will be described.

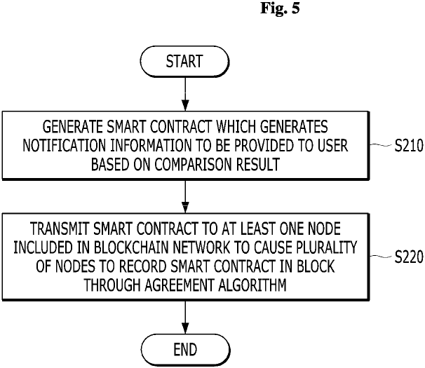

FIG. 5 is a flowchart for describing an example of a method for recording a smart contract in a blockchain network by a server according to some exemplary embodiments of the present disclosure.

Referring to FIG. 5, the processor 110 of the server 100 may generate the smart contract which generates the notification information to be provided to the user based on the comparison result (S210). The notification information may be information for transferring a notification to a user related to the external sensor 200. As an example, the notification information may be information for transferring the notification to a delivery driver who operates the moving body.

The smart contract may be a function in which an action and an execution condition are created in advance as a digital language, and the action is automatically executed when the corresponding condition is satisfied. Specifically, the smart contract may determine a change value for the sensing value based on the comparison result, and generate notification information when the change value is a predetermined second threshold or more.

For example, the internal temperature value of the moving body, which is represented by the first sensing value may be 24° C. and the internal temperature value of the moving body, which is represented by the second sensing value may be 27° C. Since the second sensing value is different from the first sensing value, the comparison result of the first sensing value and the second sensing value may be recorded in the blockchain network 400. The comparison result recorded in the blockchain network 400 may include information on the change value for the sensing value being 3° C. The smart contract may determine that the change value for the sensing value is 3° C. based on the comparison result recorded in the blockchain network 400. The predetermined second threshold for the change value stored in the storage unit 120 may be 3° C. When a change value changed from the first sensing value to the second sensing value is 3° C. or more, the smart contract may generate the notification information.

As another example, the internal temperature value of the moving body, which is represented by the first sensing value may be 26° C. and the internal temperature value of the moving body, which is represented by the second sensing value may be 27° C. Since the second sensing value is different from the first sensing value, the comparison result of the first sensing value and the second sensing value may be recorded in the blockchain network 400. The comparison result recorded in the blockchain network 400 may include information on the change value being 1° C. The smart contract may determine that the change value for the sensing value is 1° C. based on the comparison result recorded in the blockchain network 400. The predetermined second threshold for the change value stored in the storage unit 120 may be 3° C. When a change value changed from the first sensing value to the second sensing value is less than 3° C., the smart contract may not generate the notification information.

The communication unit 130 transmits the smart contract or the transaction including the smart contract to at least one node included in the blockchain network 400 to cause the plurality of nodes to record the smart contract or the transaction including the smart contract in the block through the agreement algorithm (S220).

According to the above-described configuration, the server 100 may generate a smart contract which generates notification information to be provided to the user based on the comparison result, and record the comparison result in the blockchain network 400. The smart contract may determine whether to generate the notification information by not directly comparing the first sensing data and the second sensing data, but using only the comparison result recorded in the blockchain network 400. As a result, the smart contract may rapidly determine whether abnormal data is generated. Moreover, since the smart contract generates the notification information through rapid determination, a user who receives the notification information may also rapidly sense and cope with that an internal environment of the moving body is rapidly changed eventually.

Hereinafter, an exemplary system for performing the method for storing the data by the server 100 will be described.

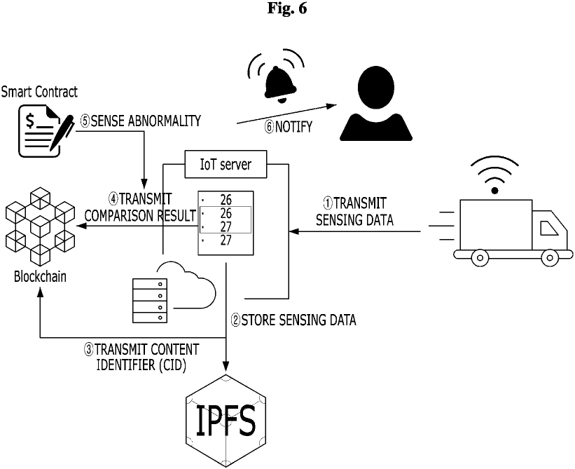

FIG. 6 illustrates an exemplary system for performing an example of a method for storing data by a server according to some exemplary embodiments of the present disclosure. In order to avoid duplicated disclosure for features described above among technical features expressed in FIG. 6, the above-described contents are referred to, but in FIG. 6, a description thereof will be omitted.

Referring to FIG. 6, the external sensor 200 may transmit at least one sensing data to the server 100. The server 100 may store at least one received sensing data in the external storage 300. The server 100 may record a CID generated as at least one sensing data is stored in the external storage 300 in the blockchain network 400. Since the server 100 may compare a first sensing value included in first sensing data which is consecutively received among at least one sensing data and a second sensing value included in second sensing data, the server 100 may determine whether there is a change. When there is the change, the server 100 may record the comparison result in the blockchain network 400. The smart contract may monitor the comparison result recorded in the blockchain network 400 in real time. When the change value is a predetermined threshold or more based on the comparison result the smart contract may generate the notification information. The server 100 may transmit the generated notification information to a user terminal.

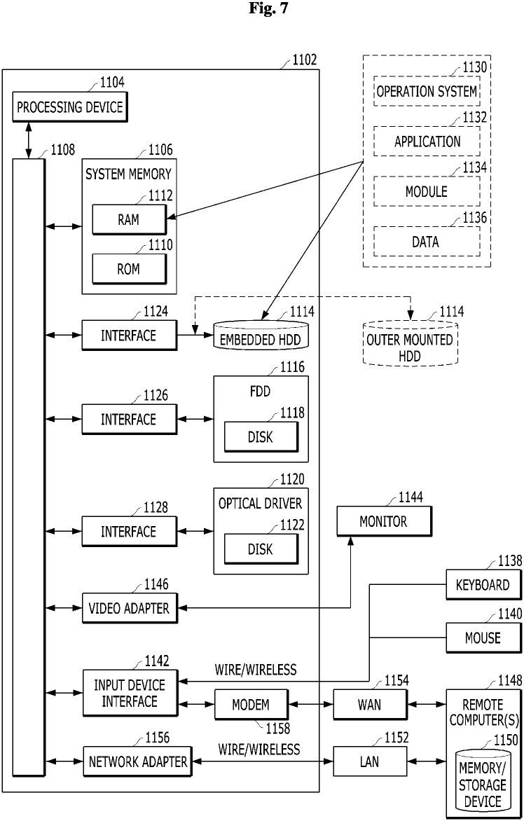

FIG. 7 is a general schematic view of an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devicesas well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. The computer includes, as a computer accessible medium, volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of anymedia among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA) - the internal hard disk drive 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example,at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term “manufactured article” includes computer programs or media which are accessible by a predetermined computer-readable device. For example, a computer readable storage media includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” includes a wireless channel and various other media that can store, possess, and/or transfer instruction(s) and/or data, but is not limited thereto.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for storing data performed by a server including at least one processor, the method comprising:
when first sensing data and second sensing data are received from an external sensor, determining whether to store the first sensing data and the second sensing data in an external storage;
when determining to store the first sensing data and the second sensing data in the external storage, transmitting a first CID(content identifier) generated as the first sensing data is stored in the external storage and a second CID generated as the second sensing data is stored in the external storage to at least one node included in a blockchain network to cause a plurality of nodes to record the first CID and the second CID in a block through an agreement algorithm;
determining whether there is a change for a sensing value based on a comparison result for a second sensing value included in the second sensing data and a first sensing value included in the first sensing data; and
when it is determined that there is the change, transmitting the comparison result to at least one node included in the blockchain network to cause the plurality of nodes to record the comparison result in a block through an agreement algorithm.

2. The method of claim 1, wherein the external storage is an InterPlanetary File System (IPFS) type of storage.

3. The method of claim 1, wherein when determining to store the first sensing data and the second sensing data in the external storage, transmitting a first CID generated as the first sensing data is stored in the external storage and a second CID generated as the second sensing data is stored in the external storage to at least one node included in a blockchain network to cause the plurality of nodes to record the first CID and the second CID in a block through an agreement algorithm includes
generating a first transaction with the first CID as a payload and a second transaction with the second CID as a payload, and
transmitting the first transaction and the second transaction to at least one node included in the blockchain network to cause the first CID and the second CID to be recorded in a block.

4. The method of claim 1, wherein the second sensing data is data received after the first sensing data is received, and
wherein when the first sensing data and the second sensing data are received from the external sensor, determining whether to store the first sensing data and the second sensing data in the external storage includes
determining whether sensing data of a predetermined amount or more is collected as the second sensing data is received, and
when it is determined that the sensing data of the predetermined amount or more is collected, storing the first sensing data and the second sensing data in the external storage.

5. The method of claim 4, wherein the storing the first sensing data and the second sensing data in the external storage includes
generating a first set of objects by splitting the first sensing data into object units, and generating a second set of objects by splitting the second sensing data into the object units, and
hashing the first set of objects and the second set of objects, and storing in the external storage.

6. The method of claim 5, wherein each of the first set of objects and the second set of objects is hashed in a merkle Directed Acyclic Graph (DAG) structure, and stored in the external storage.

7. The method of claim 1, wherein the determining whether there is the change for a sensing value based on a comparison result for a second sensing value included in the second sensing data and a first sensing value included in the first sensing data includes
determining that there is the change when it is determined that the first sensing value and the second sensing value are different, or
determining that there is the change when it is determined that a difference between the first sensing value and the second sensing value is a predetermined first threshold or more.

8. The method of claim 1, further comprising:
generating a smart contract which generates notification information to be provided to a user based on the comparison result; and
transmitting the smart contract to at least one node included in the blockchain network to cause a plurality of nodes to record the smart contract in a block through an agreement algorithm.

9. The method of claim 8, wherein the smart contract determines a change value for the sensing value based on the comparison result, and generates the notification information when the change value is a predetermined second threshold or more.

10. A server for storing data, the server comprising:
a communication unit receiving first sensing data and second sensing data from an external sensor; and
a processor determining whether to store the first sensing data and the second sensing data in an external storage when the first sensing data and the second sensing data are received from the external sensor,
wherein the processor
when determining to store the first sensing data and the second sensing data in the external storage, transmits a first CID(content identifier) generated as the first sensing data is stored in the external storage and a second CID generated as the second sensing data is stored in the external storage to at least one node included in a blockchain network through the communication unit to cause a plurality of nodes to record the first CID and the second CID in a block through an agreement algorithm,
determines whether there is a change for a sensing value based on a comparison result for a second sensing value included in the second sensing data and a first sensing value included in the first sensing data, and
when it is determined that there is the change, transmits the comparison result to at least one node included in the blockchain network through the communication unit to cause the plurality of nodes to record the comparison result in a block through an agreement algorithm.

11. A computer program stored in a computer-readable storage medium, wherein when the computer program is executed by one or more processors, the computer program executes a method for storing data, the method comprising:
when first sensing data and second sensing data are received from an external sensor, determining whether to store the first sensing data and the second sensing data in an external storage;
when determining to store the first sensing data and the second sensing data in the external storage, transmitting a first CID(content identifier) generated as the first sensing data is stored in the external storage and a second CID generated as the second sensing data is stored in the external storage to at least one node included in a blockchain network to cause a plurality of nodes to record the first CID and the second CID in a block through an agreement algorithm;
determining whether there is a change for a sensing value based on a comparison result for a second sensing value included in the second sensing data and a first sensing value included in the first sensing data; and
when it is determined that there is the change, transmitting the comparison result to at least one node included in the blockchain network to cause the plurality of nodes to record the comparison result in a block through an agreement algorithm.
